(19) United States
(12) Patent Application Publication
(10) Pub. No.: US 2013/0305675 A1
(43) Pub. Date: Nov. 21, 2013

(54) Mower for Steep Slope, Tight Area and Ditch Mower

(71) Applicant: Marco Pare, Sherbrook (CA)

(72) Inventor: Marco Pare, Sherbrook (CA)

(21) Appl. No.: 13/472,728

(22) Filed: May 16, 2012

(51) Int. Cl. A01D 34/73; A01D 69/00; A01D 67/00

(52) U.S. Cl. 56/10.8; 56/255; 56/320.1

(57) ABSTRACT

A mowing tool using a line or blade to safely and easily mow steep hills from any direction. This device can easily and safely be lifted off the mowing surface without strain nor damage to the unit. Another novelty is the method used to change a trimmer line for a blade. The device has a detachable contouring protective skirt which simplifies cleaning the device while protecting surroundings. The handle has a torquing mechanism which allows the user to optimize applied force by allowing a smooth yet powerful movement which decreases operating time and reduces user fatigue. The pivot frame is attached to a rotating disc which allows the user to mow in any direction. The pivot frame can also be extended further enhance utility. These characteristics enhance security and decrease risk of injury by helping the user to eliminate useless risks and remain on stable ground to mow slopes.

### FIELD OF THE INVENTION

The present invention relates to the field of vegetation trimming tools consisting of rapidly spinning lines or blades for mowing. More specifically, this unit is a new design for a carriage, a cutting mechanism and handle mechanism to maintain control, minimize physical strain and enhance user safety while mowing steep slopes, ditches and tight areas.

### DESCRIPTION OF RELATED ART

The use of spinning lines or blades to cut grass weeds or foilage is common knowledge. Several wheeled mechanisms have been designed in the past and are aimed at helping the user to maintain an even horizontal grass cut or simply to aid the user in carrying the weight burden of the trimming device during use. Many trimming devices exist either in the form of hand held units or carriages to cradle hand held units. Other existing units are simply hand held trimmers with wheels. Some of these carriages have telescopic handles but do not offer a means to allow the user the ability to safely mow steep hills from a long distance. Available technology always keeps the user very close to the unit. Findings of prior art show that no similar apparatus exists that possesses the unique characteristics and advantages of the present invention.

Know prior art includes

US Patent Documents

| | | |
|---|---|---|
| 4,287,709 | Joseph M Lowry | Sep. 8, 1981 |
| 4,287,709 | Joseph M Lowry | Sep. 8, 1981 |
| 4,389,836 | Joseph M Lowry | Jun. 28, 1983 |
| 4,428,183 | Joseph M Lowry | Jan. 31, 1984 |
| 4,411,126 | Joseph M Lowry | Oct. 25, 1983 |
| 5,287,683 | Walker M Smith | Feb. 22, 1984 |
| 4,756,147 | Kennerh J Savell | Jul. 12, 1988 |
| 7,617,661B2 | Harry Teruel Faeldan | Nov. 17, 2009 |
| 7,107,745B2 | Michael D Dunda | Sep. 19, 2006 |

### SUMMARY OF THE INVENTION

This invention is to overcome the disadvantages of current steep slope, tight area and ditch mowing techniques and the shortfalls of current available equipment.

Current equipment designs for mowing steep hills do not allow the user to maintain control over the equipment at all times and require alot of physical strength, endurance and dexterity. Mowing steep hills and ditches with current available mowers can be hazardous due to tip-overs, physical strain, physical danger to the user, bystanders and pets, damage to the unit, damage to property and inability of current designs to withstand the physical forces involved in mowing steep slopes and ditches while maintaining control over the unit. Current equipment designs do not allow the user to place the mower at the exact desired location at all times and withstand the forces involved.

This invention is an extremely light and rigid carriage supported by wheels or a hovering mechanism connected to a telescopic and pivoting handle to allow the user to mow dangerous areas from a safe distance. The user has the ability to mow in a vertical movement or in a horizontal movement or both, whichever is the safest and most convenient. This invention allows the user to have complete control of the unit at all times while maintaining a safe position on sure ground. The user can mow in any preferred direction and can at any moment instantly remove the device from the cutting area to avoid objects or to reposition the device to maximize utility. This invention is designed to have the ability to be completely lifted off the ground with complete ease at a far distance without bodily strain or damage to the equipment.

The present invention uses a new line adaptor which connects the cutting medium to the motor. This adaptor can serve as the height cutting adjustment and allows the user to quickly change the trimming line or to install a blade. The adaptor minimizes user investment in complex mechanisms which also add weight to the apparatus.

The present invention incorporates a 360 degree skirt to protect user, bystanders and surroundings from flying debris. This skirt is designed to be lightweight and facilitates the task of cleaning the carriage.

The present invention incorporates a pivot frame which allows the user to easily counter tip-over forces and maintain even pressure on the carrige. The pivot frame joins the telescopic handle to the platform. This pivot frame allows the user to maintain control of the platform on any axis to maximize security and cutting quality whether the user is mowing bottom-up, top to bottom or side to side.

The telescopic pole can easily be detached from the pivot frame so the unit can be used as a push mower. The pivot frame can either be telescopically lengthened or lengthened with a swing bar. A secondary trigger mechanism is located on the pivot frame or the swing bar.

The trigger mechanism has a torquing ability to allow the user to apply a constant force. This enhances fluidity of movement which increases efficiency, safety, reduces operating time and allows a quick and far reaching movement.

The present invention is constructed of rigid and lightweight materials to enable it to withstand very extreme leverage forces necessary to slope mowing and repositioning of the unit without damaging the unit and risking bodily harm.

The present invention also incorporates a mechanism on the pivot frame to overcome the danger of having the cutting medium face the user while lifting the unit with the pole

### DESCRIPTION OF THE DRAWINGS

FIG. 1 Shows a top view of the carriage, the pivot frame and pivot adaptor.

FIG. 2 Shows a side view of the shaft adaptor and inserted nylon cord.

FIG. 3 Shows a side view of the shaft adaptor and blade.

FIG. 4 Shows a thicker bottom part of line adaptor.

FIG. 5 Shows the bottom view of line adaptor.

FIG. 6 Shows a side view of the entire mower.

FIG. 7 Shows a side view of the telescopic pole and trigger handle.

FIG. 8 Shows a larger side view of FIG. 5.

FIG. 9 Shows a cross-cut of the rotating portion of the trigger handle assembly.

FIG. 10 Shows an example of vertical mowing and possible lifting of carriage.

FIG. 11 Shows a sample of the lifting action of the carrige.

FIG. 12 Shows a view of the lifting action when used horizontally.

FIG. 13 Shows the pulling mechanism to distribute force.

FIG. 14 Shows the pivot frame with swinging extension.

FIG. 15 Shows the pivot frame with extension fully opened.

FIG. 16 Shows the telescopic pivot frame.

FIG. 17 Shows the function of the pulling levers.

FIG. 18 Shows the rail system attached to the rotating disc on top of carriage.

### DETAILED DESCRIPTION OF THE DRAWINGS

The present invention is a grass trimming tool composed of a wheeled or hovering platform with a central motor which can be electric, battery or gas powered, a cutting adaptor, a rotating handle connected to a telescopic handle connected to a pivot frame to allow the user to mow steep slopes with minimal effort and in a manner to maximize safety, utility and minimize physical strain. The user can easily maintain control of the unit from long distances when perform mowing activities on steep slopes that cannot be cut with current available techniques. The unit also has the ability to mow under large low fixed objects such as a trampoline or a parked trailer without any modifications or adjustments. The unit also has the ability to convert to a push mower when required.

The steep hill mowing abilities of this invention allows the unit to mow in an upward & downwards motion with a rotating trigger handle mechanism to allow smooth and powerful movement. The design of the pivot frame, the construction of the carriage and the fixing unit allow the user to totally lift the unit at full telescopic length without strain nor damage to the unit.

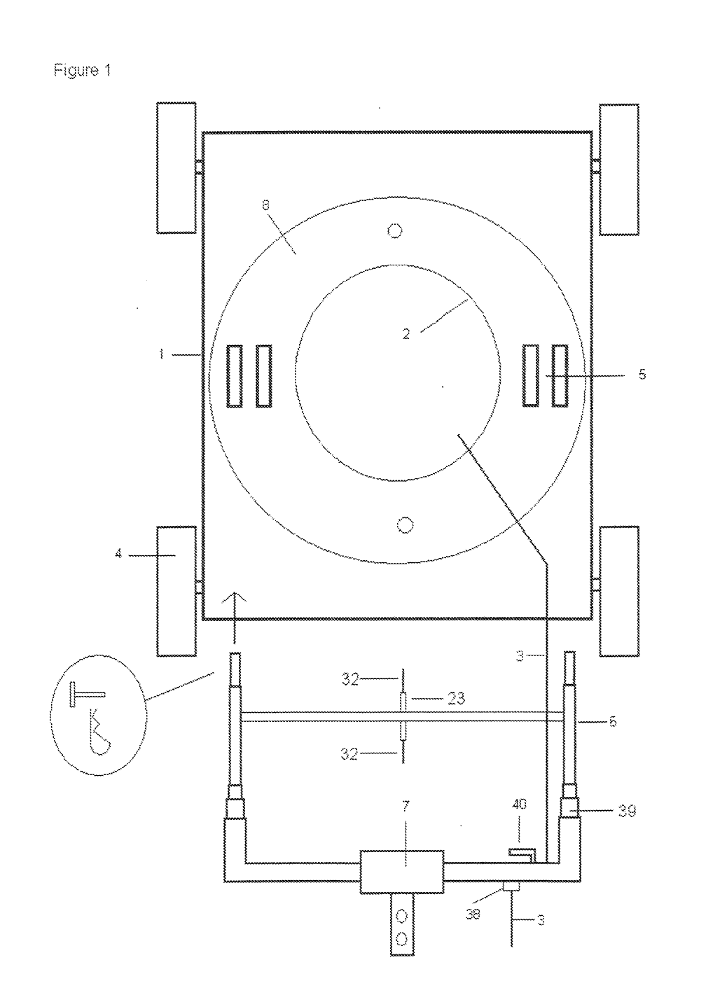

The present invention is designed to allow users to mow steep hills regardless of physical strength and abilities with minimal effort and minimal risk. FIG. 1 shows a top view of the unit. The carriage is an extremely light unit body construction (1) and has an opening (2) to support an electric, battery or gas motor not inserted in this image. The shaft of the motor extends below the unit and has an adaptor to hold either a line or blade. The electric line (3) is attached to the pivot frame secondary trigger (40) which has a plug (38) to connect the electric line to the telescopic pole the trigger assembly. Items (4) are the wheels which give the unit stability and movability. Items (5) are the pivot points that are fixed to a rotating disc (8) on the top of the carriage which allows the user to change mowing direction and receives pulling pressure from the force transfer mechanism (23). Item (6) is the pivot frame which supports, directs and allows the user to mow steep hills which are preceded by an obstacle or convert to a fixed mower by the means of a swinging mechanism or an incorporated telescopic extension (39). Item (7) is the fixing unit that holds the telescopic pole to the pivot unit.

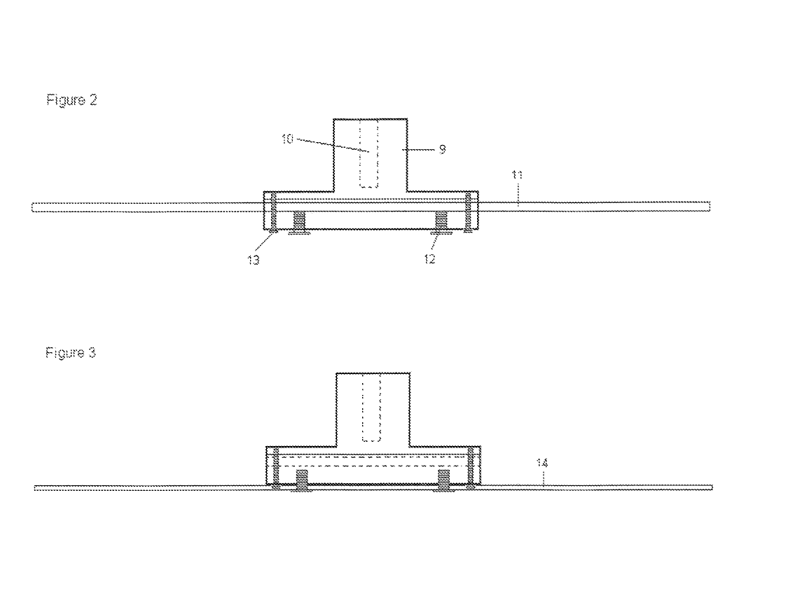

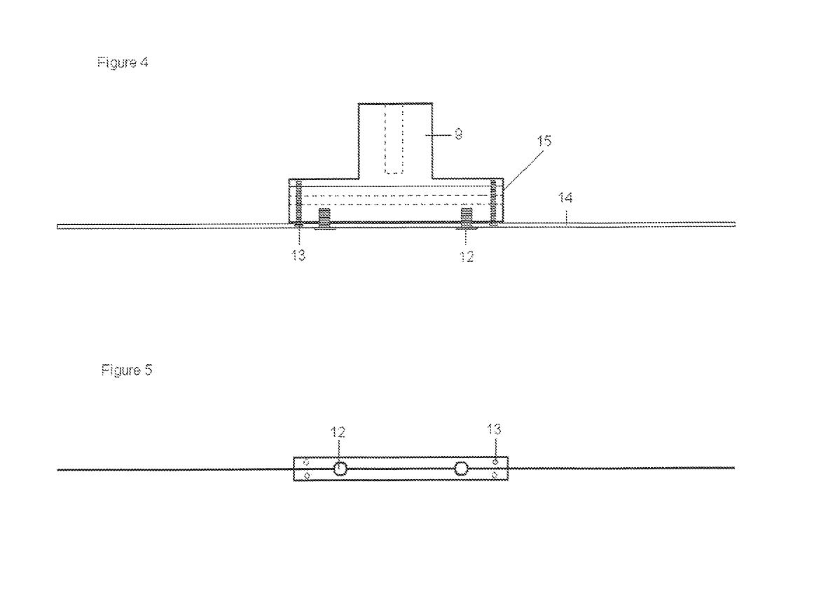

FIG. 2 shows the unique cutting unit which is attached to the motor shaft (10). The shaft adaptor allows a straight nylon cord (11) to be inserted and securely held in place by screws (12) to perform mowing activities. Items (13) are the 4 screws which connect the top and bottom parts of the line adaptor. The user can quickly change the bottom part to change cutting height. The shaft adaptor also allows for unique blades to be inserted and securely held in place to rotate and perform mowing activities. FIG. 3 shows that the user only needs to remove two screws, detach the cutting line and insert a blade (14) which is especially made to fit the core and securely held by the same screws which hold the trimming cord.

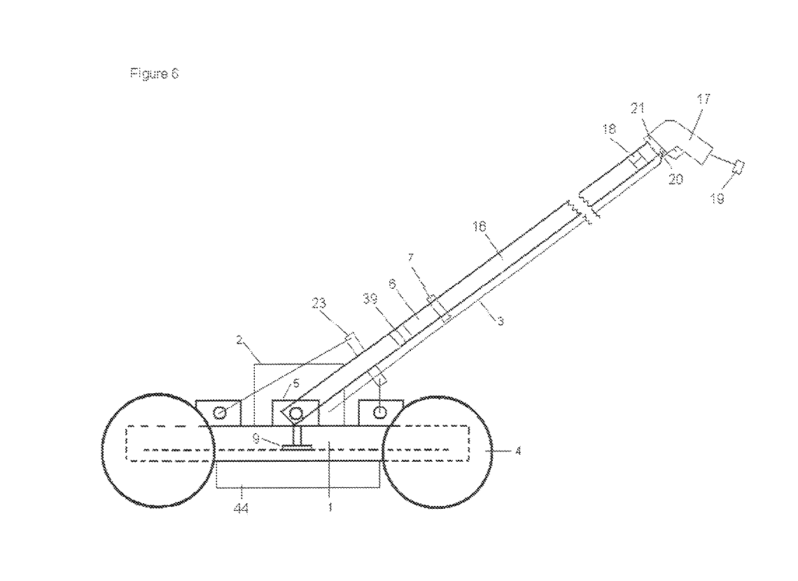

FIG. 4 is another view of the line adaptor but shows a thicker bottom portion. This diagram shows the blade secured by (12) and (13) securing bottom to top of line adaptor.

FIG. 5 shows a bottom view of the line adaptor equiped with a nylon cutting cord. The diagram also shows line securing screws (12) and the screws which secure the bottom and top pieces.

FIG. 6 is a side version of the unit and again shows the essential elements numbered the same as previous figures. The drawing shows the unit body carrige (1), the motor housing (2). The electric cord running from the motor to the trigger handle (3), the wheels (4), the pivot attach points (5), the pivot frame (6), the fixing unit to attach pivot frame to telescopic pole (7), the incorporated pivot frame telescopic extension (39), the force transfer mechanism (23), the telescopic pole (16), the rotating trigger handle (17), the telescopic pole adjustment lock mechanism (18), the power plug (19), the orifice where the power cord from motor enters the pivoting trigger handle (20) and the trigger handle torquing mechanism (21). Also shown is the screened protective skirt (44) which is lightweight and eases cleaning with compressed air or brush.

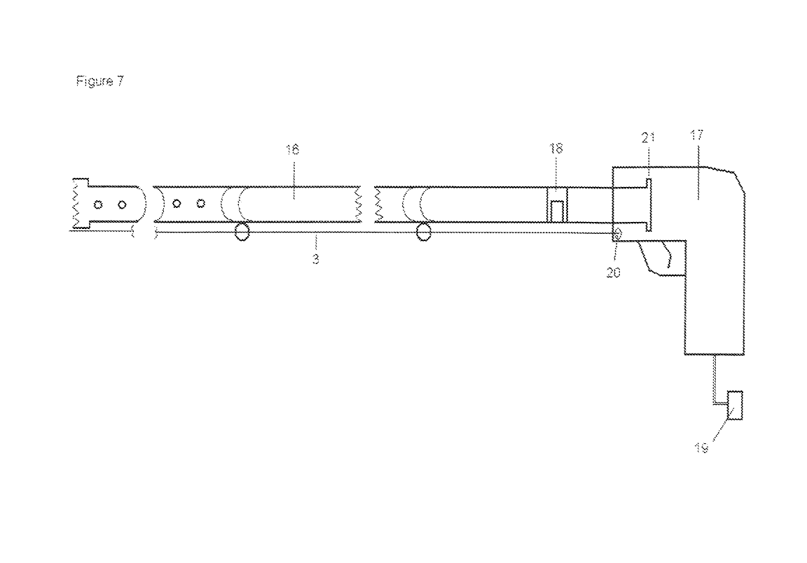

FIG. 7 is the telescopic pole (16) and trigger mechanism (17) which allow the user to control power to the motor. The telescopic pole can be extended and secured with the tightening mechanism (18). Power input (19) is sent by the trigger mechanism (17) to the motor. The entire trigger handle has a rotating torquing ability and is securely held by a blocking mechanism (21) in a cavity within the trigger handle. This system also allows the user to lock the handle in a fixed position.

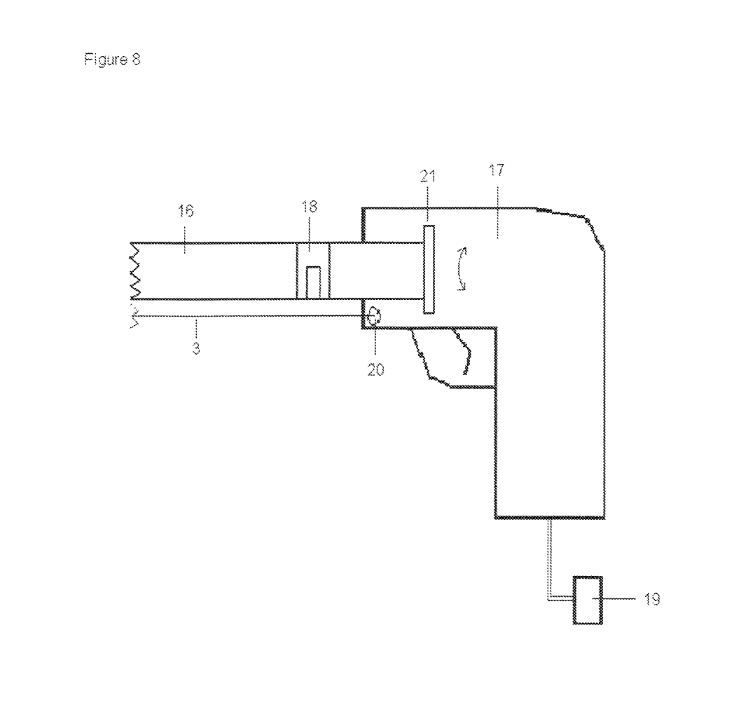

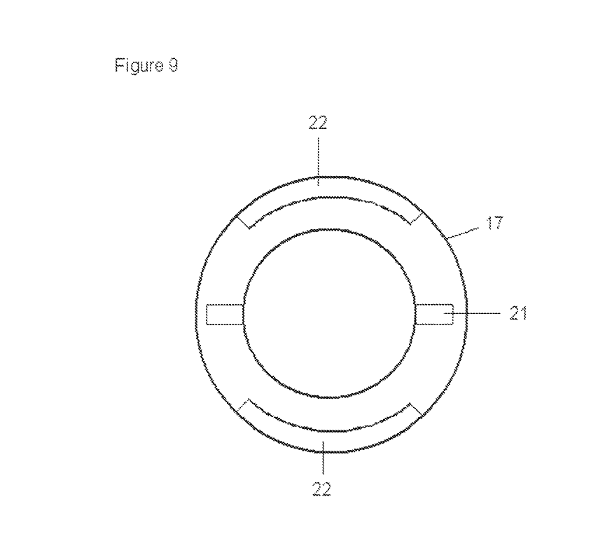

FIG. 8 is a more precise drawing of the trigger mechanism and indicates that the trigger handle (17) can have a circular rotation movement for the unique torquing ability. This torquing ability is guided by the 180 degree pivoting handle which allows force to be evenly transferred into a fluid movement while moving the mower and holding the trigger. Another benefit of this mechanism is the incease in efficiency, decrease in user fatigue and reduction of risk of injuries. The user has the option to lock the mechanism in a desired position.

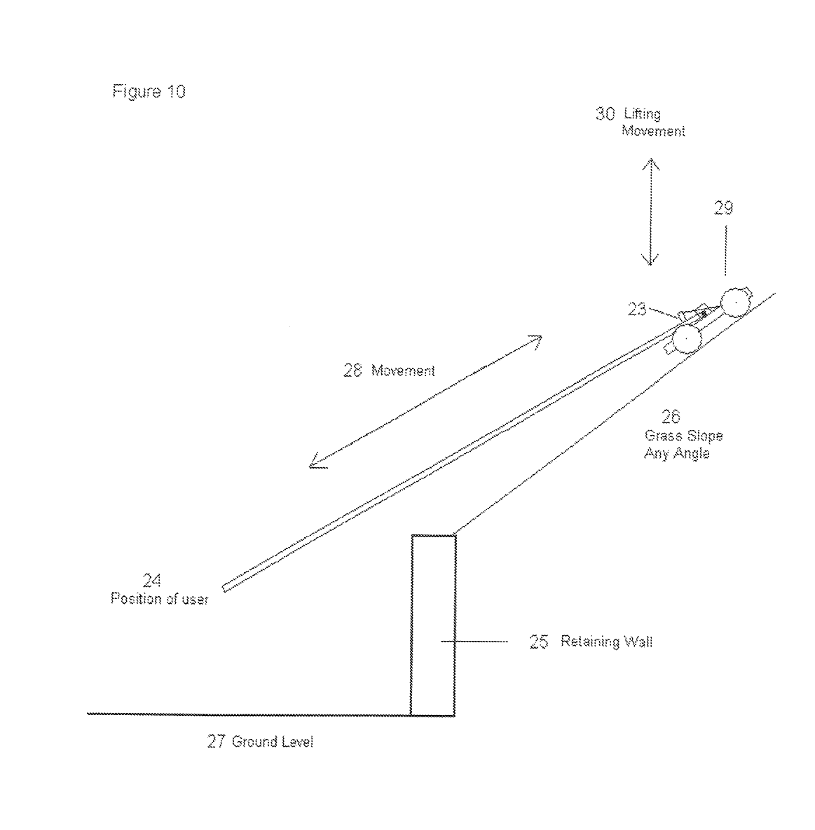

FIG. 9 shows a cross-cut of the trigger handle where (17) is the outside perimeter of the handle. The tabs fixed to the end of the telescopic pole (21) are secured inside a round cavity within the trigger handle and allow rotational movement only. In order to disassemble the trigger handle from the telescopic pole we would need to cut the trigger handle down the center. The interior cavity which allows the rotational movement has incorporated stoppers (22) to avoid 360 degree rotation of the handle on the pole.

FIG. 10 shows the type of terrain the unit can mow. The user is located at position (24) facing an obstacle (25) with any inclined slope (26). The user located at ground level (27) needs to push in a vertical up-down movement (28). Occasionally, the user may need to reposition the unit or simply lift the unit to contour an obstacle. To move the unit from position (29) to position (30), the unit requires the incorporated unique attributes to avoid user strain, fatigue, body injury and damage to the unit. FIG. 8 also shows the force transfer mechanism (23) which also has the function to prevent the carriage from tilting forwards or backwards.

FIG. 11 shows the forces the unit needs to withstand in order to function as required. In order for the user (31) to lift the device off the ground at full extension, the pole needs to withstand a lever effect and bear at least 10× the actual weight of the unit without breaking. It is imperative that the mower to be extremely lightweight and the pole very strong and light. This allows the user to lift the unit regardless of where the unit is located on the slope and regardless of where the user is situated. This lifting can be done without damaging the pole or the unit. Existing machines do not offer this functionality and would easily bend or break.

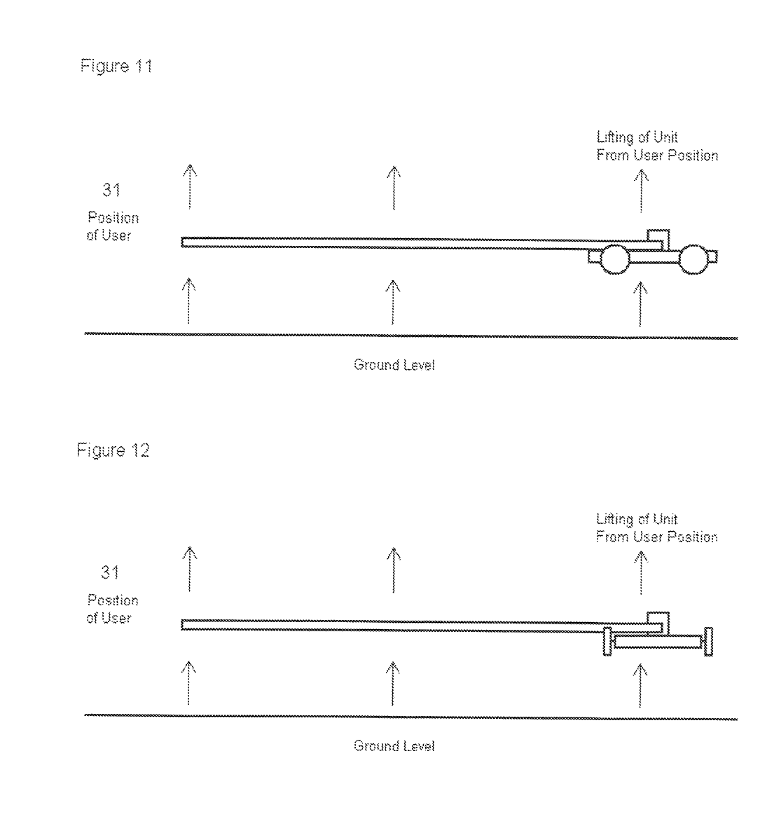

FIG. 12 is another version of FIG. 11. It shows the unit placed for a horizontal mowing movement to be lifted, once again, without strain nor damage.

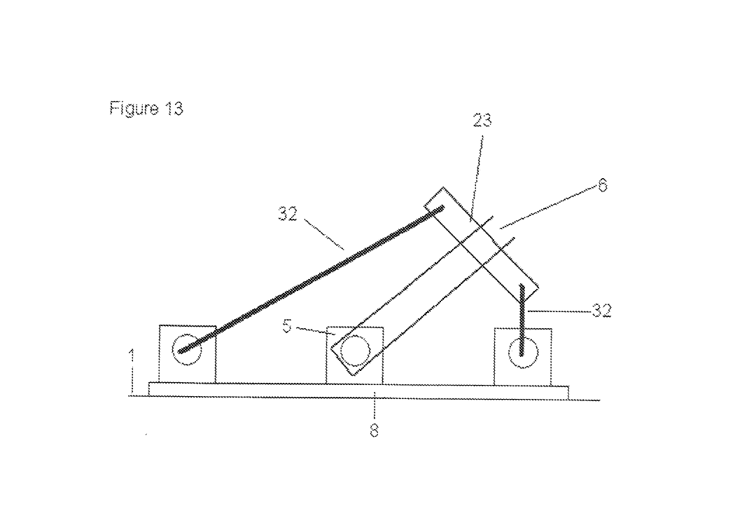

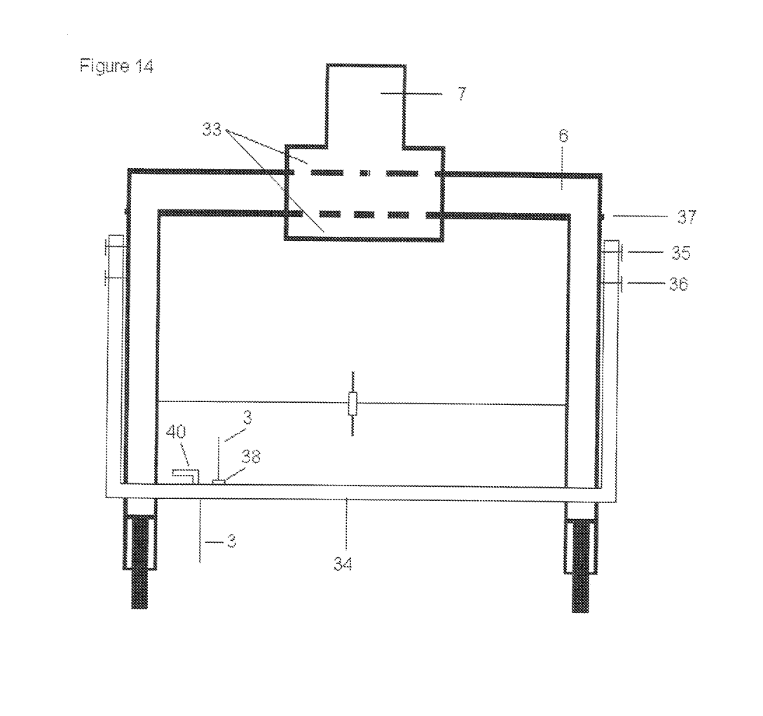

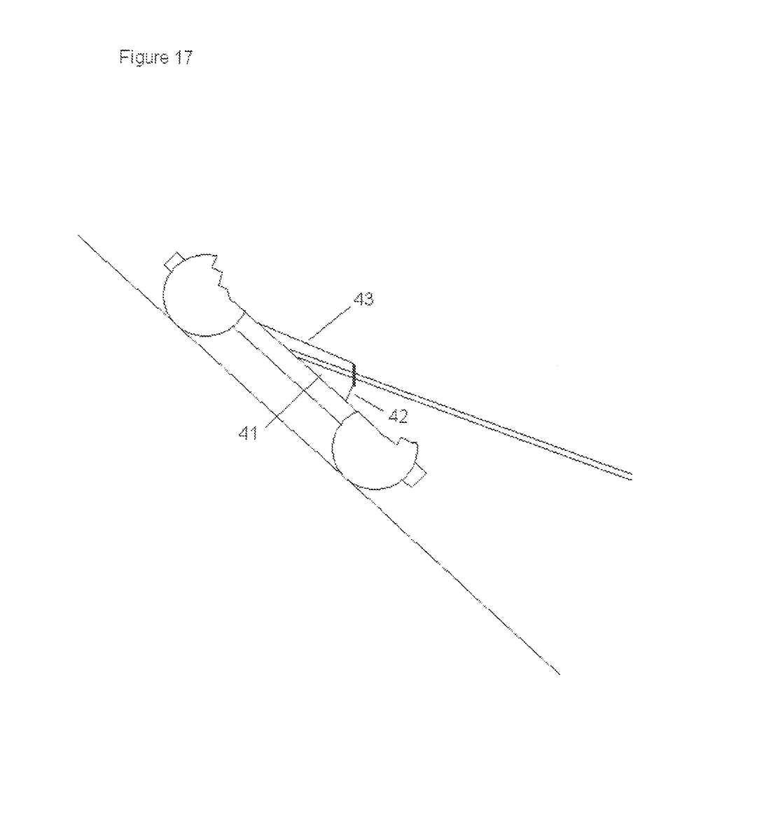

FIG. 13 shows the force transfer mechanism (23) fixed to the pivot frame (6). The lever can rotate on it's axis to allow the two pulling spring mechanisms of different lengths and coefficients (32) to alternate positions. These pulling mechanisms are attached to the fix points on the rotating disc (8) located on the top of the carriage. To further explain, FIG. 17 shows that as the carriage is pushed up the hill, the angle (41) increases and generates more pulling from (42). Since user has selected this position, puller (43) has a less spring force constant, the pull on (42) is larger and forces the front of the carriage down. The user has the option to remove this system in order to reduce weight.

FIG. 14 shows the pivot frame (6) with the attached swing pole extension (34) which allows the user to convert to a push mower. In order to convert, the user must unplug the trigger handle power cord (38) which will now supply power directly from power source to the secondary trigger (40) and to the motor by power cord (3). The user would then unlatch the securing pin (36), extend the swing pole (34) to the open position and attach securing pin (36) to the secondary orifice (37). FIG. 14 also shows that the fixing unit (7) allows a certain flexing due to the cavity being larger than the pivot frame and padded with compressable material (33). This flexing aids the pivot frame to have twisting properties which allows the user to steer the carriage.

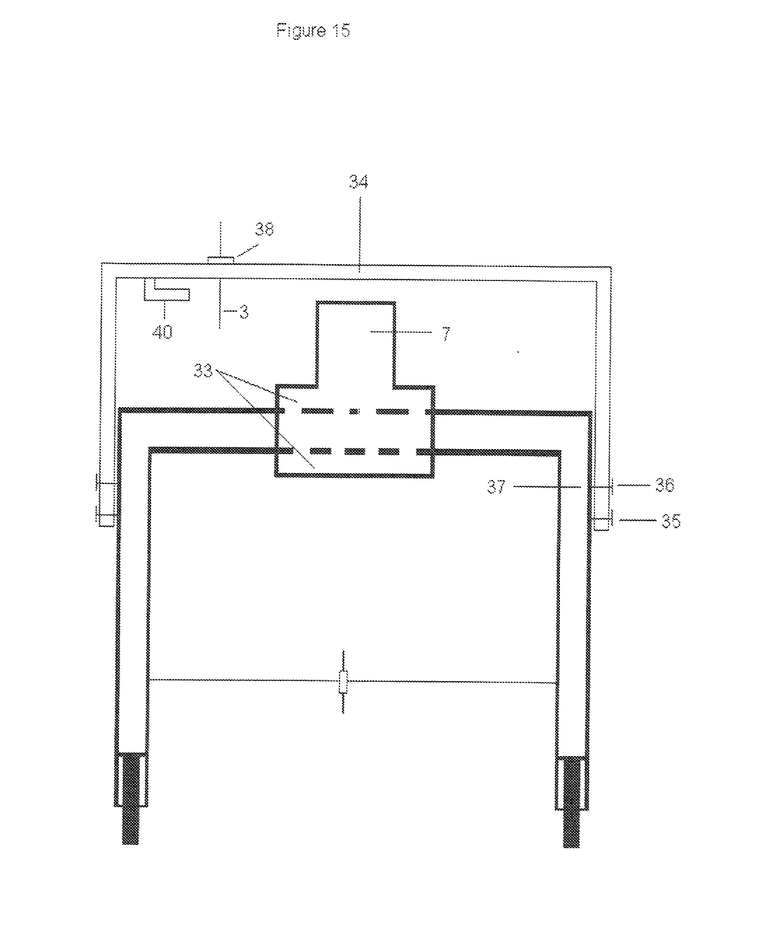

FIG. 15 is a replica of FIG. 14 but shows the swing pole fully extended to transform the pivot frame into a pushmower structure.

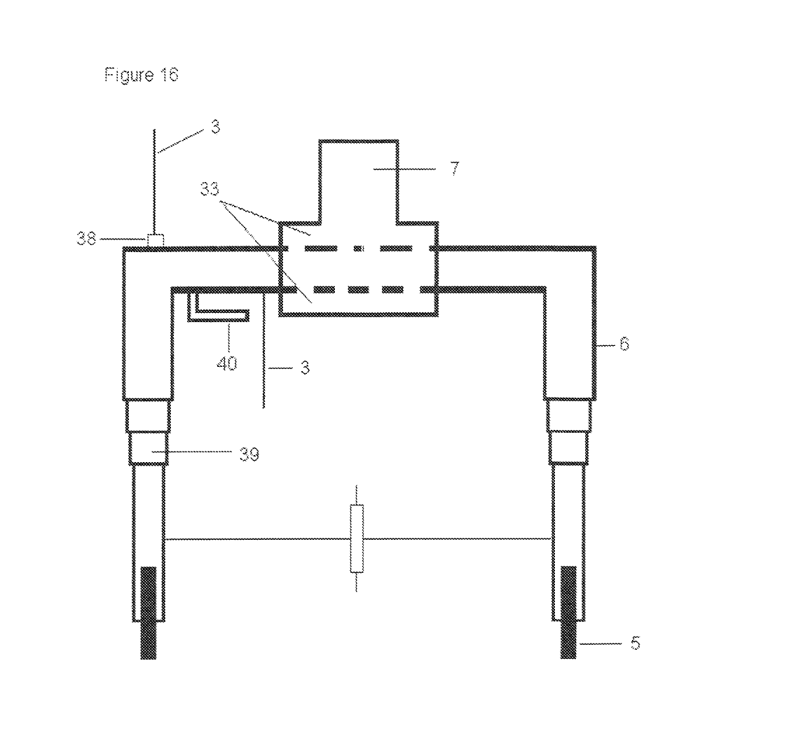

FIG. 16 is a a telescopic version of FIG. 14. In order to extend the pivot frame to use the carriage as a push mower, the user must disconnect the power supply cord (3) from plug (38) and detach the telescopic pole from the fixing unit (7). The user must then attach a direct power supply cord directly into plug (38). The user then needs to extend the telescopic tubing (39) to have a fully extended pivot frame. Again, the user will control power to the motor by secondary trigger (40). As in FIGS. 14 and 15, the fixing unit has a torsion ability due to the compressable material (33).

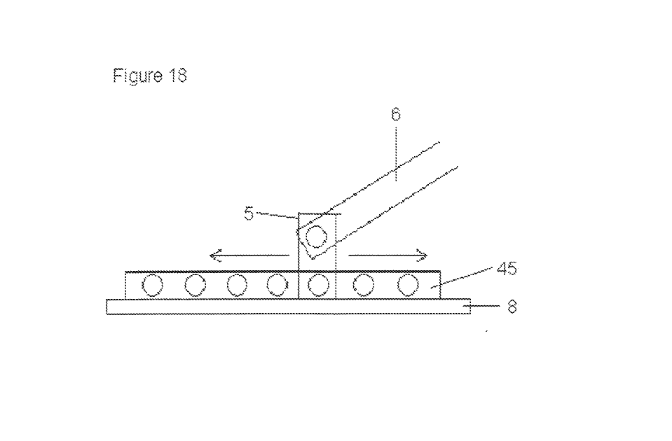

FIG. 18 shows the rail system (45) that can be attached to the rotating disc (8) on top of the carriage. The pivot frame attached to the fix point (5) can be moved closer to front or back of the carriage along the adjusting frame (45) to facilitate use and enhance security.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A carriage which can either be supported by wheels or hover suspension with a motor, a cutting medium such as a blade or line rotating at high speeds, enclosed within a protective skirt and attached to a force optimizing pivot frame, fix points or rail system, a pulling mechanism, a fixing unit, a telescopic handle and a rotating trigger mechanism which aids the user to mow steep hills in a fluid manner which maximizes force, ease of operation and safety to mow in either an upward/downward or horizontal manner or a combination of both.

18. The said cutting mechanism under the carriage in claim 1 is surrounded by a protective skirt made of a light perforated material which increases the ease of cleaning and protects the user, bystanders and objects from flying debris.

19. The cutting skirt in claim 1 has the ability of being detached at any of the extremities of the carriage to allow the user to expose the trimming medium to allow to trim wall-type edges.

20. The said cutting mechanism in claim 1 is designed to be of extreme light weight material and has the ability to quickly change the cutting medium from a line to a blade by either attaching the blade with screws or pass the line through a tunnel tube in the cutting mechanism which uses the same screws to secure the line.

21. The said pivot frame in claim 1 has a pulling mechanism which permits the user to choose the appropriate front/back force allowing the frame to better dissipate user force and gravitational force against the carriage, thus constantly applying a more uniform pressure to the carriage.

22. The pulling mechanism in claim 1 has the versatility of being spring operated, hydraulic, electric, remote control or manual and controlled either from the pivot frame, the telescopic pole or the trigger handle; the user may detach this system if slopes to mow are of lower grade and user desires to reduce weight.

23. The said pulling mechanism in claim 1 can be replaced by the user for the described rail system attached to the rotating disc to allow the pivot frame to be attached to various points.

24. The pivot frame in claim 1 is attached to the carriage by a rotating disc on top of the carriage which can be rotated to allow the user to change mowing direction from up/down to horizontal.

25. The said fixing unit and pivot frame in claim 1 is designed to have the ability to quickly and easily detach the telescopic pole and convert into a handle which allows the carriage to be used as a push mower allowing to mow small grades, flat surfaces, between and under objects and other applications which suits the user.

26. The said pivot frame in claim 1 can be extended to convert the system to a push mower by unfolding a swing pole extension containing a secondary trigger and an electrical plug allowing the user to completely disconnect the telescopic pole and related input power; a by-pass outlet allows the unit to be directly be powered at the secondary trigger level.

27. The said pivot frame in claim 1 can be extended telescopically to convert the system to a push mower by detaching the telescopic pole and bypassing power at the secondary trigger level.

28. The said fixing unit in claim 1 which connects the telescopic pole to the pivot frame has the unique ability to enable the user to steer the carriage by dissipating the applied push force by having an inner compression medium.

29. The said pivot frame in claim 1 is attached to fix points which allow the pivot frame and telescopic handle to allow the carriage to safely attain an angles of operation between 0 and 90 degrees and between 290 and 360 degrees.

30. The said pivot frame in claim 1 is designed to assure the cutting medium never faces the user during lifting movements.

31. The said trigger handle in claim 1 has the ability to rotate on the telescopic pole allowing the user to adopt a fluid movement thus reducing operating time, user fatigue and the risk of injury and strain.

32. The unique properties of this device allow the user to completely lift the unit off the mowing surface at all times from zero extension to full extension without damage to the unit and with minimum strain to the user.
